(19) United States
(12) Patent Application Publication
(10) Pub. No.: US 2003/0154159 A1
(43) Pub. Date: Aug. 14, 2003

(54) Auction-subscription system for priority website access

(76) Inventors: Mark Andrew Dinan, Pasadena, CA (US); Munir Frederick Bhatti, Arcadia, CA (US); Jennifer Yun-Man Sun, Pasadena, CA (US); Ann M. Pickard, Pasadena, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/338,549

(22) Filed: Jan. 8, 2003

Related U.S. Application Data
(60) Provisional application No. 60/347,147, filed on Jan. 11, 2002.

(51) Int. Cl. G06F 17/60

(52) U.S. Cl. 705/37

(57) ABSTRACT

A method and system for granting access by all the users who logon to a website so long as the website has not reached a predetermined capacity of use but however, denying access to such a user if the capacity of use of the website has reached a predetermined level unless the user is in possession of a valid website pass and allowing any user not having such a pass the ability to acquire the same at a predetermined price or alternatively to bid for a pass by a different amount. When a user having a valid website pass logson and the website is beyond the predetermined capacity, that user is allowed immediate access and a user who is logged on but does not possess a valid website pass is automatically removed from the website.

### RELATED APPLICATIONS

This application is based upon provisional patent application No. 60/347,147 filed Jan. 11, 2002 entitled Auction-Subscription System for Priority Website Access and the benefit of that application is hereby claimed.

### BACKGROUND OF THE INVENTION

1. Field of the Invention

This invention relates to a subscription-auction system for website access that is based upon site usage and resource load.

2. Description of Prior Art

Current models for revenue for content-based website generally depend upon subscription and/or advertising. To date the sites having the most success with the subscription model tend to be websites dealing in pornography. The prevalent concern is that web users still overwhelmingly believe that content on the Internet should be free and would balk at being asked to pay for a subscription. Most websites have therefore depended on advertising as their main source of revenue. As income from advertising depended upon user visits and page views, websites are doubly reluctant to move to a subscription model, for fear that it would mean a drastic drop in site usage that would ultimately decimate their advertising revenue.

Advertisers however have become increasingly aware that savvy web-surfers tend to pay little or no attention to traditional banner advertisements. Coupled with small advertising budgets in a slower economy, websites are finding that survival based solely upon advertising is no longer viable.

The challenge is therefore to devise a revenue model that can aid users to transition from the concept that web content should be free to the understanding that quality web content, just like quality TV on cable, deserves to be paid for. In order to achieve this, the model needs to allow users to help set prices, as well as maintain site usage and loyalty.

### SUMMARY OF THE INVENTION

A method for granting access by a user to a website which includes allowing access to the website by all users who log on so long as the website has not reached a pre-determined capacity of use, providing means on the website for a potential user to obtain a website pass valid for a predetermined period of time, storing in a database the identity of each user possessing a website pass and the date of expiration thereof, querying the database each time a user logs on to the website to determine whether that user possesses a valid website pass, allowing immediate access only to each user having a valid pass irrespective of website capacity and denying access at the time of log on to all users not possessing a valid website pass when the website use has exceeded the pre-determined capacity.

### BRIEF DESCRIPTION OF DRAWINGS

FIG. 1 illustrates the decision process that applies to each user that arrives on the site to determine whether access is allowed.

FIG. 2 illustrates the decision process for a user who has not yet obtained a valid access pass.

### DETAILED DESCRIPTION

The goal of this invention is to provide a system having a revenue model that:

1. Ties revenue closely to the real costs per user, such as bandwidth and server resources, rather than content.

2. Maintains site usage at a level that is critical for concurrent revenue sources, such as advertising, or for user dynamics, if the site supports a virtual community.

3. Allows user to participate actively in setting of the subscription price.

The system is built upon the premise that access to a give site is free, as long as site resources, such as CPU, bandwidth, hard-disk activity, etc., are being utilized below target levels. When resource utilization increases above this level, a state that may be determined by a high number of user connections for example, only paying users are able to enter the site. Paying users are, in a sense, holders of a valid or priority pass. The premise of the system is summarized as follows:

1. Website X's capacity is limited to N amount of resources (CPU, bandwidth, hard-disk activity, etc.).

2. All users of Website X, paying and non-paying, are allowed onto the site when the resource need as determined by the number of users is below N.

3. When resource need rises above N, only users who have paid for priority access by purchasing a valid pass are admitted onto the Website X.

4. Users are encouraged to purchase the pass at a pre-determined price or alternatively to bid an amount to have unlimited access to the site for D days (30, for example).

5. Users who pay the predetermined price are allowed immediate access.

6. At the end of each auction period, which may be at the end of the day, the bids are evaluated and some number of the top bidders win unlimited access for the next D days.

This system has the following advantages:

1. Conveys to users that payment is tied to site resources and bandwidth rather than content.

2. Allows users to participate actively in the setting of the subscription price.

3. Allows users to pay according to their means, achieving maximum breadth of customer base.

4. Maintains site usage and activity at a critical level at all times.

5. Improves site speed and responsiveness by limiting access.

6. Distributes site usage more evenly.

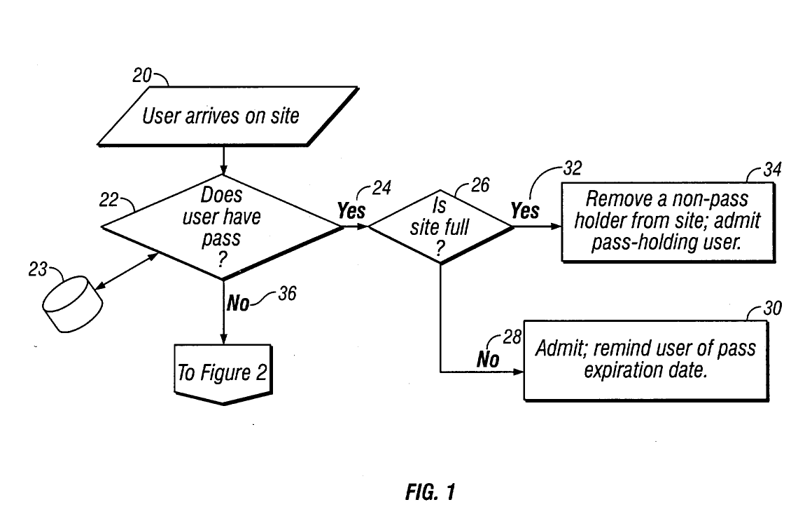

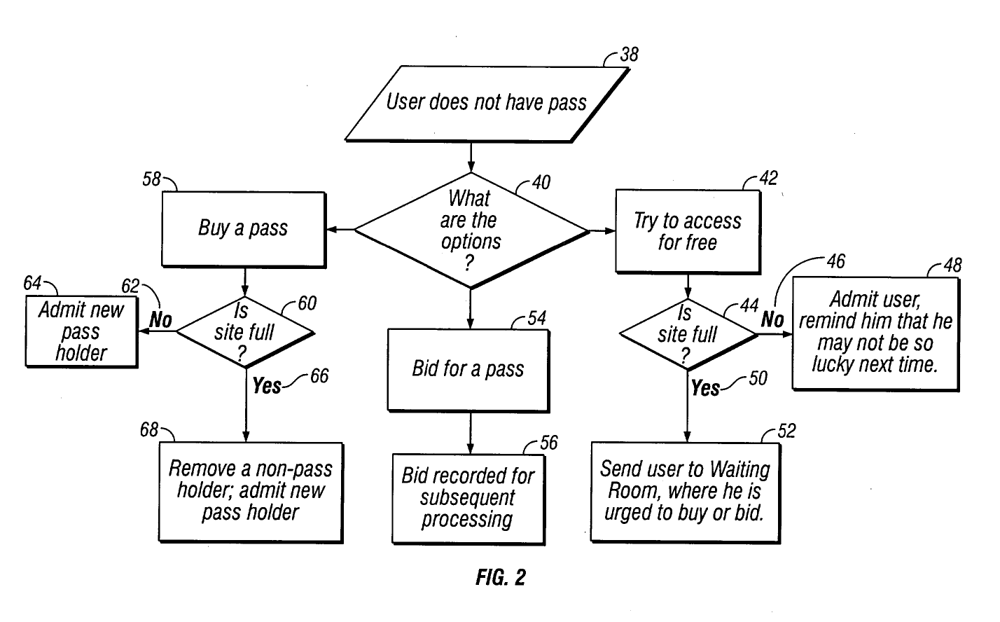

The operation of the system constructed in accordance with the present invention is illustrated in FIGS. 1 and 2. As is illustrated in FIG. 1 to which reference is hereby made, a user arrives at the website by logging on as shown at 20. After log on, the system first determines whether or not that user possesses a valid pass that has been previously obtained. This is illustrated at 22. The determination is made by the system querying a database 23 which contains the identity of each user having previously acquired a valid pass allowing immediate access to the website.

If upon such query the database does provide the information that the user who has logged on does have a valid pass then such is indicated as shown at 24. The next query that must be made is to determine whether or not the website resource utilization is above or below the target level which has been determined. As above indicated, this target level can be established by various parameters such as CPU, bandwidth, hard disk activity and the like. For the most part, determination of whether or not these resources are being used at their fullest capacity can be determined by the number of user connections to the website. In any event, the query, irrespective of how the resource use is measured, will provide a determination as to whether or not a pre-determined target level has been exceeded. If such has not been exceeded which would be indicated as shown at 28, then the user who has logged on is immediately admitted as shown at 30. As is also indicated when the user is admitted, that user will be reminded of the expiration date of the valid pass which the user possesses. The system may also automatically notify each user holding a valid website pass that his/her pass will expire within a pre-determined period of time unless it is renewed. For example, this may be accomplished by querying the database 23 for the identity of all pass holders whose passes will expire within the next five (5) days and automatically sending a message by e-mail or on the user's PC screen to that effect.

If on the other hand at the time of the query as to whether or not the website resources are being utilized above the pre-determined target level the answer is that such is in fact the case then that will be designated as shown at 32. When such occurs, since the user has a valid site pass, this provides a priority of access to that user over other users who may be logged on to the website at that particular point in time who do not have a valid website pass. As a result, as is shown at 34, the system will select a user who is logged on the website and who does not have a valid site pass and will remove that user from the website to provide room for the user who has just logged on and is in possession of a valid website pass.

Various criteria can be utilized to determine which user who is logged on to the website should be removed to make room for the newly logged on user having the valid website pass. Typically, this will be done by first identifying all of the users who are logged on to the website who do not have the pass. Thereafter, the system will determine those users not possessing the valid website pass who have been logged on for the longest period of time without website activity for a predetermined period of time. Such a user would then be automatically logged out by the system to provide space for the new user who has just logged on and possesses the valid website pass. The user who has been automatically logged out would be notified by a message appearing on the user's PC screen indicating that they have been automatically logged out because they did not possess a valid pass and the website is at full use capacity. This user would be sent to a room on the website which would provide information regarding of a valid pass by paying a pre-determined sum of money for that pass or alternatively by submitting a bid of an amount less than the pre-determined amount which if accepted would provide the user with a valid pass. The room may also have additional information concerning the website as for example such that would appear on a traditional home page for a website.

Alternatively, the user selected for removal from the website may be given a notification prior to being removed which informs this user that the website use is such that the target level has been exceeded and it is necessary to remove a non-valid passholding user from the website to make room for a newly logged on user having a valid website pass. The system would then provide information to the user about to be removed that if that user wishes, the user may purchase a valid website pass at that moment for a pre-determined sum of money for a pre-determined period of time. If that user possesses a valid credit card and provides that information to the system and is cleared, then that user will be issued a website pass and may remain on the website. Under these circumstances, the system would then pick an alternative user not possessing a valid website pass to automatically log out.

Alternatively, the system may automatically log out the non-passholding user and at the time of the log out and the notification give that user an opportunity to purchase a valid website pass and then the ability to log back on to the website if desired. If the user elects to do this, and the system is still being overutilized (that is beyond the pre-determined target level), the system will select a non-passholding user to automatically log out and the process above described will again be carried out.

If as is illustrated in FIG. 1 the user who has logged on as shown at 20 is identified as not holding a valid site pass which is indicated at 36 then the process as illustrated in FIG. 2 will be followed and reference is hereby made to that illustration. As shown therein at 38 the user who has logged on as shown at 20 in FIG. 2 is identified by the database 23 as not having a valid pass. Under these circumstances, that user has three options as shown at 40. The first of these options is to attempt to maintain access as shown at 42 for free irrespective of the possession or non-possession of valid website pass. Should such be the selection by the user 20 then the system will query as to whether or not its usage is beyond the pre-determined level as is illustrated at 44. If the system determines that it is not at an overcapacity level as shown at 46, then the user who has logged on without the valid pass will be admitted the website as shown at 48. As is indicated at 48 that user even though admitted will be notified that in the event the site is over capacity at the next time that user logs on they may not be able to obtain access. In the event when the site capacity is queried as shown at 44, the responses that it is overcapacity as shown at 50 then the user who has logged on will be sent to a waiting room as shown at 52 which as above described will inform the user as to why access was denied and to provide that user with an opportunity to either acquire a valid pass by paying a pre-determined amount for that or alternatively to submit a bid for a pass. If bid submission process is chosen, then the user will be notified as to the evaluation and acceptance or rejection of the bids. Alternatively, the user may continue to try and log on for free as many times as the user chooses.

As is shown at 54, an additional option which is available to the user who has logged on who does not have a pass is to submit a bid for a pass. If that option is chosen, then as is shown at 56 the user will submit a bid of the user's choosing for a valid pass for some preselected period of time. That user will be notified of the bid processing sequence typically at the close of a pre-determined period of time such as the end of a day or the like. All of those bids which have been submitted during the preceding pre-determined period of time will be evaluated and a pre-determined number of those bids will be selected. All of the individuals submitting bids will then be notified as to whether or not that individual's bid has been selected or rejected. If a bid has been selected, then the user whose bid has been selected must pay for the pass according to the bid previously submitted. Typically what will occur is at the time of the submission of the bid, the user will have also provided that user's credit card, identification information and authorization to charge the card. The card will not be charged unless the bid has been accepted but when it is accepted, the card will be charged that amount and the user notified. Subsequent thereto the identification of the user and the fact that the user now possesses a valid pass will be recorded in the database 23 along with the expiration date of that pass. Therefore, when that user next logs on as shown at 20, that user will be provided priority access to the website irrespective of whether the site is at over capacity or not. The third option for the user who has logged on and who does not have a pass as shown at 38 is to purchase a pass as is illustrated at 58. Under these circumstances, the user will be given the option of purchasing a pass for a pre-determined amount of money. If the user elects this option, then again a query will be made as to whether or not the site is at over capacity as shown at 60. If the site is not at overcapacity as illustrated at 62, then the user will be immediately admitted to the site as shown at 64. If however when the site utilization is queried as shown at 60, it is determined that the site is at overcapacity as illustrated at 66, the new pass holder who has purchased the pass as shown at 58 will be admitted as shown at 68. At the same time a non-passholding user will be removed from the system as was described above with regard to the first option available to the user who does not have a pass.

There has thus been described an auction subscription system for priority website access which differs from existing subscription systems in that site membership remains free to all those desiring such. It must be understood that the subscription is not for a membership. The subscription is for a priority pass that allows the user in possession thereof to enter the site at all times irrespective of the usage capacity thereof. During those periods when the site resource needs are low, then entry is free for all users. It is only during the times that the capacity of the site is overused that entry to the site is denied to those not holding a priority pass. In addition as above described, the invention provides a bidding process that allows each of the users to determine for themselves what price they are willing to bid or pay for priority access privileges to the website.

What is claimed is:

1. A method for granting access by a user to a website comprising:
a. allowing access to said website to all users who log on to said website so long as said website use has not reached a predetermined capacity;
b. providing means on said website for a potential user to obtain a website pass valid for a predetermined period of time;
c. storing in a database the identity of each user possessing a website pass and the date of expiration thereof;
d. querying said database each time a user logs on to said website as to the existence of a valid website pass attributable to that user;
e. allowing immediate access only to each user identified on said database having a valid pass irrespective of website capacity; and
f. denying access at the time of log on to all users not possessing a valid website pass when said website use has exceeded said predetermined capacity.

2. A method as defined in claim 1 wherein said step of providing means to obtain a pass includes the step of purchasing a pass.

3. A method as defined in claim 2 wherein said pass may be purchased for a predetermined sum of money.

4. A method as defined in claim 2 which includes the further step of providing means for a user to bid for a pass.

5. A method as defined in claim 4 which further includes the step of notifying a user as to the acceptance or rejection of the user's bid.

6. A method as defined in claim 1 which includes the further step of removing a user not in possession of a valid pass from said website when said website use has exceeded said predetermined capacity and a user having a valid pass logs on to said website.

7. A method as defined in claim 1 wherein said predetermined capacity is determined by the number of users logged on to said website.

8. A method as defined in claim 4 which includes the further step of evaluating all bids received during a predetermined time period and determining those bids which are acceptable and notifying each user bidder as to whether that user bidder's bid was accepted or rejected.

9. A method as defined in claim 6 which includes the further step of notifying non-valid pass holders logged on to said website that they may be removed and providing each of said non-valid pass holders the opportunity to purchase a pass.

10. A method for granting access by a user to a website comprising:
a. establishing a target level for website usage capacity;
b. determining website unused capacity at the time a user logs on to said website;
c. granting access to said user when said website is determined to have unused capacity at the time a user logs on to said website;
d. determining whether said user possesses a valid website pass when said website is determined to have no unused capacity at the time a user logs on to said website;
e. allowing immediate access to said website by said user if said user possesses a valid pass;
f. denying access to said website by said user if said user does not possess a valid pass; and
g. providing said denied access user an opportunity to acquire a valid pass.

11. A method as defined in claim 10 which includes the further step of storing in a database the identity of each user possessing a valid pass and the expiration date thereof.

12. A method as defined in claim 11 wherein said step of providing said denied access user an opportunity to acquire a valid pass includes the step of purchasing a pass for a predetermined sum of money.

13. A method as defined in claim 11 which includes the further step of providing means for a user to bid for a pass.

14. A method as defined in claim 13 which further includes the step of notifying a user as to the acceptance or rejection of the user's bid.

15. A method as defined in claim 10 which includes the further step of removing a user not in possession of a valid pass from said website when said website use has exceeded said predetermined capacity and a user having a valid pass logs on to said website.

16. A method as defined in claim 15 which includes the further step of notifying non-valid pass holders logged on to said website that they may be removed and providing each of said non-valid pass holders the opportunity to purchase a pass.

17. A method as defined in claim 10 which includes the further step of providing a user denied access the ability to try to log on to said website for free as often as said user desires.

18. A method as defined in claim 10 which includes the further step of notifying each holder of a valid website pass that said pass will expire within a predetermined period of time.

19. A method as defined in claim 18 wherein said user is provided the opportunity to renew the website pass for a further predetermined time.
